(19) United States
(12) Patent Application Publication
(10) Pub. No.: US 2014/0072813 A1
(43) Pub. Date: Mar. 13, 2014

(54) POLYAMIDE-IMIDE SOLUTION AND POLYAMIDE-IMIDE FILM

(71) Applicants: Mari Fujii, Shiga (JP); Tomonori Iwamoto, Shiga (JP); Masatoshi Hasegawa, Chiba (JP)

(72) Inventors: Mari Fujii, Shiga (JP); Tomonori Iwamoto, Shiga (JP); Masatoshi Hasegawa, Chiba (JP)

(21) Appl. No.: 14/112,503

(22) PCT Filed: Apr. 19, 2012
(86) PCT No.: PCT/JP2012/060624

§ 371 Date: Oct. 17, 2013

(30) Foreign Application Priority Data
Apr. 20, 2011 (JP) 2011-094441

(51) Int. Cl. C09D 7/00

(52) U.S. Cl. CPC C09D 7/001
USPC 428/435; 524/233; 252/586

(57) ABSTRACT

An object of the present invention is to obtain a polyamide-imide solution that has a low linear thermal expansion coefficient, that is, an excellent linear thermal expansion coefficient, and that also is excellent in coating applicability. A further object of the present invention is to provide, with use of the polyamide-imide solution, a product or member which has high requirements for heat resistance and a low linear thermal expansion coefficient. In particular, the present invention is intended to provide a product or member that is suitably used for applications in which the polyamide-imide film obtained from the polyamide-imide solution of the present invention is formed on a surface of an inorganic material such as metal, metal oxide, or monocrystalline silicon.

The above objects can be achieved by a polyamide-imide solution including: a specific polyamide-imide; and an organic solvent, the organic solvent being a mixture solvent of an amide solvent and a non-amide solvent, the non-amide solvent being at least one solvent selected from the group consisting of ether solvents, ketone solvents, ester solvents, glycol ether solvents, and glycol ester solvents.

### TECHNICAL FIELD

The present invention relates to a polyamide-imide solution and a polyamide-imide film formed from the polyamide-imide solution. Further, the present invention relates to a laminate, a flexible display substrate, a TFT substrate, a color filter, an electronic paper, and an organic EL each of which includes the polyamide-imide film.

### BACKGROUND ART

Following recent rapid advancement in electronics including displays such as a liquid crystal display, an organic EL display, and an electronic paper, solar cells, and touch panels, demands have arisen for flexible electronic devices that have a reduced thickness and a reduced weight. In these electronic devices, various electronic elements such as a thin film transistor and a transparent electrode are formed on a glass plate. By replacing such a glass material by a film material, a reduction in thickness and weight of a panel itself can be achieved. However, for formation of such electronic elements, a high-temperature process is required.

In a case where the above-described fine elements made from an inorganic material are formed on a film, a difference in linear thermal expansion coefficient between the inorganic material and the film may cause film warping after formation of an inorganic element or worse, break the inorganic element. Accordingly, there has arisen a demand for a material that not only has a heat resistance but also has the same linear expansion coefficient as the inorganic material.

Fabrication processes of the electronic devices as described above are classified into a batch type fabrication process and a roll-to-roll type fabrication process. When the roll-to-roll fabrication process is employed, new production equipment is required and it also becomes necessary to overcome several problems caused by reeling in or a contact between films. Meanwhile, the batch type fabrication process is a process in which (i) a coating resin solution is applied onto a substrate such as a glass substrate or metal substrate, and then dried so that a substrate is formed, and (ii) subsequently, thus applied and dried coating resin solution is peeled off. Therefore, the batch type fabrication process is superior in terms of cost because processes and equipment for current glass substrates such as a TFT glass substrate can be used.

In view of a background as described above, it has been strongly demanded to develop a coating resin solution (i) that makes it possible to obtain a coating film with both heat resistance and a high dimensional stability and (ii) that also allows use of an existing batch type fabrication process in production of such a coating film.

As a material that satisfies such a demand, polyimide has been studied. Polyimide resin is excellent in heat resistance, mechanical strength, electric characteristics, and the like. Accordingly, the polyimide resin has conventionally been used widely as an industrial material in an electric field, an electronic field, a mechanical field, an aeronautical field, and the like fields. Unlike general polyimides, in particular, many known polyamide-imides are soluble in an organic solvent (see, for example, Patent Literature 1). Such polyamide-imides have suitably been used in applications, such as enamel varnish, a coating agent for electric insulation, and a painting material, where film formation with solution is essential.

Meanwhile, an amide solvent is often used as a solvent for use in dissolution of polyimide. The amide solvent has a high solubility; however, the amino solvent also has a high polarity and accordingly, easily absorbs moisture. Therefore, in an application process, the amide solvent tends to absorb moisture in the air and cause phase separation. This often causes a problem of whitening of a coating film surface. Particularly, in the case of the batch type fabrication process, it is predictable that a waiting time occurs after the application process and before a step following the application process. This means that there is a high possibility that the problem of the whitening occurs in the case of the batch type fabrication process. The whitening causes a concern over deterioration or the like of a surface nature and a problem that may consequently arise in a subsequent processing step. In order to solve this problem, development of a polyimide exhibiting solubility in a non-amide solvent has been discussed (Patent Literature 2). Further, Patent Literature 3 discloses a polyimide containing an amide group.

### CITATION LIST

### Patent Literatures

[Patent Literature 1]
Japanese Patent Application Publication, Tokukaihei, No. 5-59174 A (published on Mar. 9, 1993)
[Patent Literature 2]
Japanese Patent Application Publication, Tokukai, No. 2006-2163 A (published on Jan. 5, 2006)
[Patent Literature 3]
Japanese Patent Application Publication, Tokukai, No. 2010-106225 A (May 13, 2010)

### SUMMARY OF INVENTION

### Technical Problem

There are many known soluble polyimides. However, it is known that a polyamide-imide disclosed in Patent Literature 1 does not exhibit a low linear thermal expansion characteristic because the polyamide-imide contains an aliphatic group having a low rigidity. Meanwhile, the polyimide disclosed in Patent Literature 2 is soluble in a ketone solvent or ether solvent and can be applied without causing a whitening phenomenon. However, this polyimide includes a flexible component in a polymer skeleton and consequently, rigidity of a polymer main chain is lost. Therefore, it is difficult that this polyimide has both heat resistance and a high dimensional stability.

Patent Literature 3 synthesizes a polyamide-imide, as a soluble polyamide-imide, from diamine and tetracarboxylic dianhydride containing an amide group, by first synthesizing the tetracarboxylic dianhydride. However, Patent Literature 3 does not touch anything about a relation between a polyamide-imide solution and a linear thermal expansion coefficient. Further, Patent Literature 3 does not disclose a sufficient thermal expansion characteristic for a case where the polyamide-imide solution is applied on a base material that is made of an inorganic material. Furthermore, Patent Literature 3 does not touch anything about a solvent in preparation of a polyamide solution and coating applicability (capability of being applied to coating) of the polyamide solution.

As described above, a soluble polyamide-imide has been conventionally known. However, the polyamide-imide solution that has been disclosed so far is not a polyamide-imide solution (i) that makes it possible to form a film that has a very low linear thermal expansion coefficient and (ii) that can be applied without whitening in an application process of the polyamide-imide solution. The present invention is attained in view of the above circumstances. An object of the present invention is to obtain a polyamide-imide solution that has a low linear thermal expansion coefficient, that is, an excellent thermal expansion coefficient, and that also is excellent in coating applicability. A further object of the present invention is to provide, with use of the polyamide-imide solution, a product or member which has high requirements for heat resistance and a low linear thermal expansion coefficient. In particular, the present invention is intended to provide a product or member that is suitably used for applications in which the polyamide-imide film obtained from the polyamide-imide solution of the present invention is formed on a surface of an inorganic material such as glass, metal, metal oxide, or monocrystalline silicon.

### Solution to Problem

The inventors of the present invention found that use of a mixture solvent of an amide solvent and a non-amide solvent is very effective in achieving the above object of the present invention, that is, in obtaining a polyamide-imide solution that has an excellent solubility in an organic solvent, a low linear thermal expansion characteristic, that is, an excellent linear thermal expansion characteristic, and also an excellent coating applicability (i.e., a polyamide-imide solution (i) that includes a polyamide-imide having an excellent solubility in an organic solution and a low linear expansion characteristic, that is, an excellent linear expansion characteristic and (ii) that is excellent in coating applicability).

In order to solve the above problem, a polyamide-imide solution of the present invention includes: an organic solvent; and a polyamide-imide including a structure represented by the general formula (1) below, the organic solvent being a mixture solvent of an amide solvent and a non-amide solvent, the non-amide solvent being at least one solvent selected from the group consisting of ether solvents, ketone solvents, ester solvents, glycol ether solvents, and glycol ester solvents.

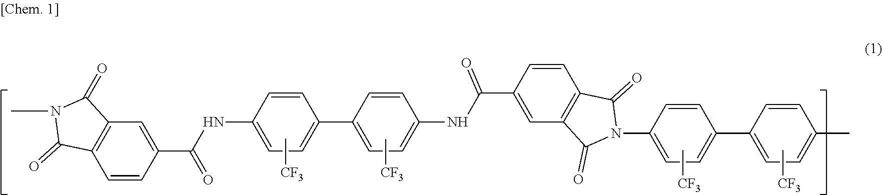

In order to solve the above problem, a polyamide-imide film of the present invention includes a polyamide-imide including a structure represented by the following general formula (1) below:

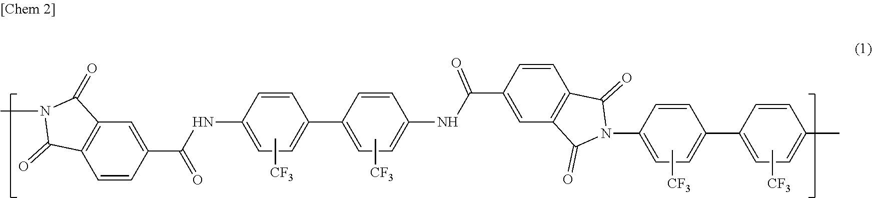

the polyamide-imide film having a birefringence ΔN of 0.040 or higher, the birefringence being expressed by ΔN=Nxy−Nz, where an in-plane refractive index is Nxy and a refractive index in a thickness direction is Nz.

### Advantageous Effects of Invention

The polyamide-imide solution of the present invention does not whiten in an application process, but shows an excellent coating applicability. Further, a polyamide-imide film obtained from the polyamide-imide solution has a very low linear thermal expansion coefficient.

### DESCRIPTION OF EMBODIMENTS

The following discusses the present invention in detail. Note that, however, the present invention is by no means limited to the description below, but various modifications can be made within the scope described below. Further, all Patent Literatures cited in the present Specification is incorporated herein by reference. In addition, note that “A to B” indicative of a numerical range means “A or more and B or less” in the present Specification unless specifically noted otherwise.

The present invention relates to a polyamide-imide solution includes: an organic solvent; and a polyamide-imide including a structure represented by the general formula (1) below, the organic solvent being a mixture solvent of an amide solvent and a non-amide solvent, the non-amide solvent being at least one solvent selected from the group consisting of ether solvents, ketone solvents, ester solvents, glycol ether solvents, and glycol ester solvents.

The present invention relates to a polyamide-imide solution more preferably includes: an organic solvent; and a polyamide-imide represented by the general formula (1), the organic solvent being a mixture solvent of an amide solvent and a non-amide solvent, the non-amide solvent being at least one solvent selected from the group consisting of ether solvents, ketone solvents, ester solvents, glycol ether solvents, and glycol ester solvents.

First, the following discusses a polyamide-imide including a structure represented by the following general formula (1).

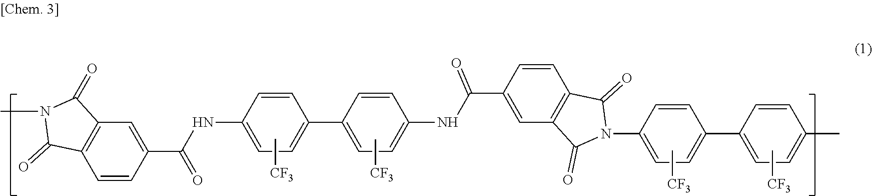

In view of obtaining both a low linear thermal expansion coefficient and solution processability/coating applicability, it is preferable to use a polyamide-imide including a structure represented by the following formula (6) among polyamide-imides including the structure represented by the above general formula (1).

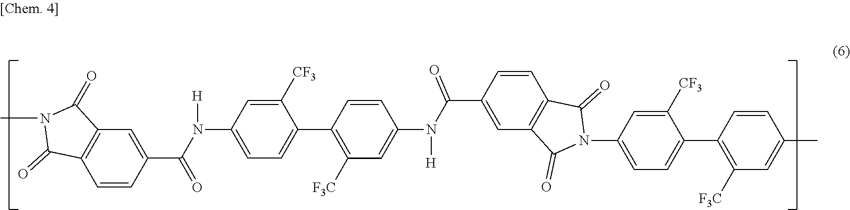

Further, the polyamide-imide including the structure represented by the above general formula (1) is more preferably a polyamide-imide represented by the general formula (1). In view of obtaining both a low linear thermal expansion coefficient and solution processability/coating applicability, it is more preferable to use a polyamide-imide represented by the formula (6) among polyamide-imides represented by the above general formula (1).

As a method for producing a polyamide-imide of the present invention is not specifically limited but a production method appropriate for achieving the object can be selected. For example, the method for producing the polyamide-imide of the present invention may be (A) a method (one-pot method) including the steps of (i) reacting trimellitic anhydride chloride with diamine represented by the following formula (2) or (3) in the presence of a solvent and (ii) imidizing, in a solution obtained in the step (i), tetracarboxylic dianhydride represented by the following formula (4), the tetracarboxylic dianhydride having never been isolated, or alternatively (B) a method including the steps of (i) reacting trimellitic anhydride chloride with diamine represented by the following formula (2) or (3), (ii) isolating and purifying tetracarboxylic dianhydride represented by the following formula (4), and (iii) imidizing thus once isolated and purified tetracarboxylic dianhydride by reacting the tetracarboxylic dianhydride with diamine. As to the method for isolating the tetracarboxylic dianhydride represented by the following formula (4) and then reacting this tetracarboxylic dianhydride with diamine, it is possible to employ a method as described in Japanese Patent Application Publication, Tokukai, No. 2010-106225 or the like. For example, Synthesis Example 2 described later employs the method for producing a polyamide-imide as described in Japanese Patent Application Publication, Tokukai, No. 2010-106225. Further, if necessary, an accelerant such as acetic acid or tertiary amine may be used.

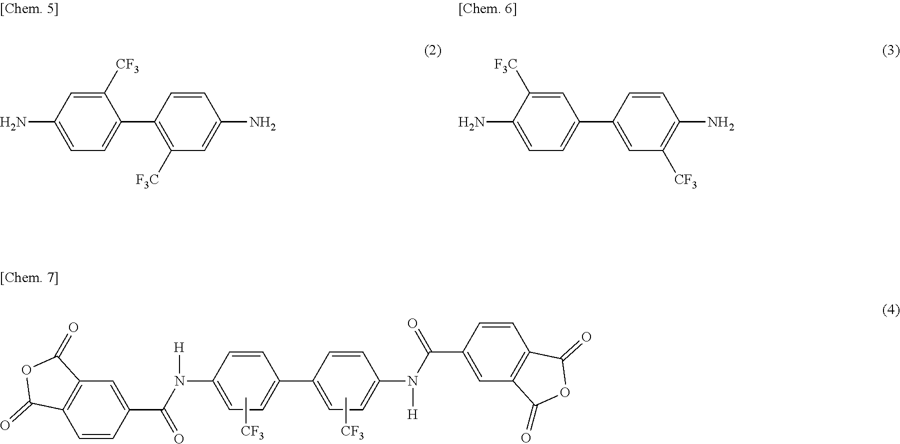

In synthesis of the polyamide-imide according to the one-pot method, a polyamide-amide acid represented by the following general formula (5) is first synthesized as a precursor of the polyamide-imide.

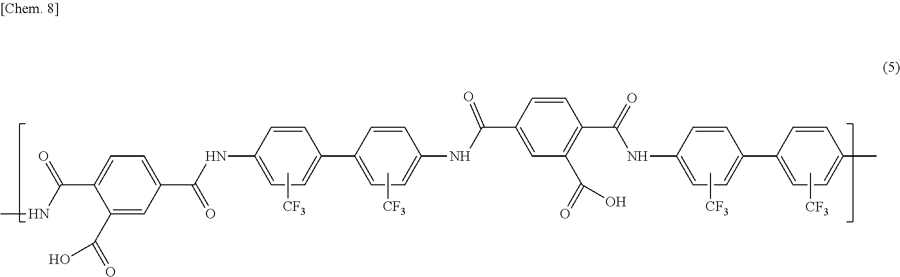

This synthesis of the polyamide-amide acid can be carried out by mixing a diamine component and trimellitic anhydride chloride. It is preferable that the diamine component and trimellitic anhydride chloride are mixed under stirring. A stirring time here is preferably 1 to 24 hours. As to a reaction temperature at stirring, an optimum temperature is selected as appropriate depending on a material in use. More specifically, the reaction temperature is preferably in a range of −10° C. to 50° C., and more preferably in a range of 0° C. to 30° C. Because a synthesis reaction of the polyamide-amide acid is a polycondensation reaction, a molecular weight can be adjusted by changing a ratio of the diamine component and trimellitic anhydride chloride that are to be mixed. The ratio can be selected as appropriate in accordance with a target molecular weight. In view of obtaining (i) solubility in an organic solvent and (ii) a low linear thermal expansion characteristic of a resultant polyamide-imide, the ratio is preferably in a range of 90:100 to 110:100. As to a method for mixing the diamine component and trimellitic anhydride chloride, it is possible to employ a method in which the above acid anhydride chloride is added to the diamine component or a method in which the diamine component is added to the above anhydride chloride. The method in which trimellitic anhydride chloride is added to the diamine component is more preferable. Moreover, an entire amount of trimellitic anhydride chloride or the diamine component may be added at a time, or the amount of trimellitic anhydride chloride or the diamine component may be added separately in parts so that the entire amount of trimellitic anhydride chloride or the diamine component is made up in total.

In the one-pot method, the organic solvent used in polymerization of the polyamide-amide acid is not specifically limited, as long as the solvent reacts with neither trimellitic anhydride chloride nor diamine for use in the polymerization and the polyamide-amide acid as a precursor can be dissolved in the solvent. Examples of such a solvent are: urea solvents such as methylurea and N,N-dimethylethylurea; sulfoxide solvents or sulfone solvents such as dimethylsulfoxide, diphenylsulfone, and tetramethylsulfone; amide solvents such as N,N-dimethylacetamide (hereinafter, also referred to as DMAC), N,N′-diethylacetamide, N-methyl-2-pyrolidone (hereinafter, also referred to as NMP), γ-butyrolactone (hereinafter, also referred to as GBL), and hexamethylphosphoric triamide; alkyl halide solvents such as chloroform and methylene chloride; aromatic hydrocarbon solvents such as benzene and toluene; and ether solvents such as tetrahydrofuran, 1,3-dioxolan, 1,4-dioxane, dimethyl ether, diethyl ether, and p-crezolmethylether. In general, these solvents may be used solely or according to need, two or more of the solvents may be used in combination. In view of solubility of the polyamide-amide acid and polymerization reactivity, DMAC, NMP, or the like is more preferably used.

As to a possible method for converting the polyamide-amide acid as a precursor of the polyamide-imide, there is a method in which the polyamide-amide acid is imidized by adding a dehydration catalyst and an imidizing agent to a polyamide-amide acid solution. Thus obtained solution containing the polyamide-imide, the dehydration catalyst, and the imidizing agent can be used as a polyamide-imide solution. Further, by introducing a poor solvent into thus obtained solution containing the polyamide-imide, the dehydration catalyst, and the imidizing agent, the polyamide-imide in a solid state can be precipitated. It is particularly preferable to employ a method in which the polyamide-imide in a solid state is once isolated. This is because according to such a method, (i) with the poor solvent, it is possible to wash and remove the dehydration catalyst, the imidizing agent, and an impurity (hydrochloride) that has been produced in synthesis of the precursor and (ii) any of various kinds of organic solvents can be selected in accordance with a substrate (also called a “support” in the present specification) that is to be coated.

The imidizing agent can be a tertiary amine. The tertiary amine is preferably a heterocyclic tertiary amine. Concrete preferred examples of such a heterocyclic tertiary amine are pyridine, picoline, quinoline, and isoquinoline. As the dehydration catalyst, acid anhydride is used. More specifically, preferred concrete examples of the acid anhydride are acetic anhydride, propionic anhydride, n-butyric anhydride, benzoic anhydride, and trifluoroacetic anhydride.

An amount of the imidizing agent to be added is 0.5 to 5.0 molar equivalent, more preferably 0.7 to 2.5 molar equivalent, and most preferably 0.8 to 2.0 molar equivalent with respect to an amide group produced by a reaction between an acid anhydride group and an amino group. Meanwhile, an amount of the dehydration catalyst to be added is 0.5 to 10.0 molar equivalent, more preferably 0.7 to 5.0 molar equivalent and most preferably 0.8 to 3.0 with respect to the amide group produced by the reaction between the acid anhydride group and the amino group.

When the imidizing agent and the dehydration catalyst are added to the polyamide-amide acid solution, the imidizing agent and the dehydration catalyst that have not been dissolved in a solvent can be directly added or alternatively, the imidizing agent and the dehydration catalyst that have been dissolved in a solvent can be added. According to a method in which the imidizing agent and the dehydration catalyst are directly added, before the imidizing agent and the dehydration catalyst are uniformly dispersed in a solution, imidization reaction may rapidly proceed locally and as a result, a gel may be produced. Accordingly, more preferably, the imidizing agent and the dehydration catalyst are first dissolved in a solvent so as to be moderately diluted and then thus obtained solution is mixed in the polyamide-amide acid solution.

In a case where, as described above, the polyamide-imide is to be obtained as a solid substance by (i) adding a dehydration catalyst and a imidizing agent to the polyamide-amide acid, (ii) completing imidization within a solution and (iii) then introducing a poor solvent into the solution, the following methods can be employed: (a) a method in which the polyamide-imide in a solid state is isolated by introducing, into a poor solvent, the polyamide-imide solution containing the polyamide-imide, the imidizing agent and the dehydration catalyst; or (b) a method in which the polyamide-imide in a solid state is precipitated by introducing a poor solvent into the polyamide-imide solution containing the polyamide-imide, the imidizing agent and the dehydration catalyst. The polyamide-imide in a solid state includes various forms, such as a powder form and a flake form, of polyamide-imide. An average particle diameter of such solid-state polyamide-imide is preferably in a range of 5 mm or less, more preferably in a range of 3 mm or less, and most preferably in a range of 1 mm or less.

The poor solvent of the polyamide-imide in the present invention can be any solvent that can be mixed with the organic solvent that is used as a solvent for dissolving the polyamide-imide. Examples of such a poor solvent for polyamide-imide are: water, methyl alcohol, ethyl alcohol, 2-propyl alcohol (isopropyl alcohol), ethylene glycol, triethylene glycol, 2-butyl alcohol, 2-hexyl alcohol, cyclopentyl alcohol, cyclohexyl alcohol, phenol, and t-butyl alcohol. Among the above alcohols, alcohols such as 2-propyl alcohol (isopropyl alcohol), 2-butyl alcohol, 2-pentyl alcohol, phenol, cyclopentyl alcohol, cyclohexyl alcohol, and t-butyl alcohol are preferable because these alcohols do not deteriorate stability and an imidization ratio of the polyamide-imide in a solid state after isolation; and 2-propyl alcohol is particularly preferable.

When the poor solvent is introduced into the polyamide-imide solution, a solid content concentration of the polyamide-imide solution is not specifically limited as long as the polyamide-imide solution has a viscosity that allows stirring. However, in view of reducing a particle diameter of the polyamide-imide in a solid state, a lower solid content concentration of the polyamide-imide solution, that is, a dilute polyamide-imide solution is more preferable. Accordingly, the poor solvent is preferably introduced into the polyamide-imide solution after the polyamide-imide solution is diluted so as to have the solid content concentration of 15% or less, and more preferably, 10% or less. Further, it is preferable that the solid content concentration of the polyamide-imide solution be 5% or higher, because an amount of the poor solvent used for precipitation of the polyamide-imide does not become too large at such a solid content concentration. The amount of the poor solvent used for precipitation is preferably equal to or more than an amount of the polyamide-imide solution, and more preferably twice to three times as much as the amount of the polyamide-imide solution. Here, the solid content indicates all components except solvent and the solid content concentration indicates a percent concentration by weight of the solid content in an entire solution.

The polyamide-imide obtained here in a solid state contains a small amount of the imidizing agent and the dehydration catalyst. Therefore, this polyamide-imide is preferably washed several times with the poor solvent, in particular, with an alcohol solvent such as 2-propyl alcohol.

A drying method for thus obtained polyamide-imide in a solid state may be either vacuum drying or hot-air drying. For the purpose of completely removing the solvent contained in the polyamide-imide in a solid state, vacuum drying is desirable. A drying temperature is preferably in a range of 100° C. to 200° C. and particularly preferably in a range of 120° C. to 180° C.

Further, the polyamide-imide including the structure represented by the above general formula (1) may be produced by (i) first applying the polyamide-amide acid solution as a precursor of the polyamide-imide onto a support and (ii) then subjecting the polyamide-amide acid solution on the support to heat imidization.

Though a preferable weight-average molecular weight of the polyamide-imide of the present invention depends on an application of the polyamide-imide, the weight-average molecular weight is preferably in a range of 5,000 to 500,000, more preferably in a range of 10,000 to 300,000, and most preferably in a range of 30,000 to 200,000. When the weight-average molecular weight of the polyamide-imide is less than 5,000, a coating film or film made of such a polyamide-imide may not be able to have a satisfactory characteristic because, for example, such a coating film or film becomes very weak. Meanwhile, when the weight-average molecular weight of the polyamide-imide is more than 500,000, a solution viscosity increases. This may result in deterioration in handleability or deterioration in solubility. Consequently, it may not be possible to obtain a coating film or film whose surface is smooth and whose film thickness is even. In other words, when the weight-average molecular weight of the polyamide-imide is 5,000 or more, a coating film or film having a sufficient strength can be easily obtained from such a polyamide-imide. Meanwhile, when the weight-average molecular weight of the polyamide-imide is 500,000 or less, solubility can be ensured. Therefore, a coating film or film whose surface is smooth and whose film thickness is even can be easily obtained from the polyamide-imide having such a weight-average molecular weight. The molecular weight here indicates a value based on polyethylene glycol measured by gel permeation chromatography (GPC).

Next, the following discusses the polyamide-imide solution of the present invention. The polyamide-imide produced by the above-described method is soluble in an appropriate solvent that exhibits solubility for the polyamide-imide. Generally, in many cases, an amide solvent is used as a solvent for dissolving the polyamide-imide. The amide solvent here means an organic solvent containing an amide group. Though the amide solvent is excellent in solubility, the amide solvent has a high moisture absorbency. Accordingly, in view of whitening of a coating film (hereinafter, also referred to as a wet film), such an amide solvent is not preferable. This is because in the case of a batch type fabrication process, it is predictable that in an application process of the polyamide-imide solution, a waiting time occurs before a following step starts. Meanwhile, many non-amide solvents exhibit a hydrophobic characteristic. Therefore, though such a non-amide solvent is inferior in solubility to an amide solvent, the non-amide solvent is effective in suppressing whitening of a wet film in an application process of the polyamide-imide solution. The non-amide solvent here means a solvent having a higher hydrophobic characteristic as compared to the amino solvent and more specifically, indicates a group of solvents including ether solvents, ketone solvents, ester solvents, glycol ether solvents, and glycol ester solvents. However, each solvent in the group of non-amide solvents generally has a low solubility for the polyamide-imide. Therefore, it is difficult that these solvents are solely used. Further, the non-amide solvent often has a low boiling point in general and such a non-amide solvent easily evaporates at a normal temperature in an application process. This may cause a change in viscosity of the polyamide-imide solution. This may also cause drying of the polyamide-imide solution on a die lip in the application process and consequently result in short-lasting application processability during application process. Further, in consideration of handleability in production, the organic solvent to be used preferably has less odor.

Accordingly, in the present invention, it was found that use of (i) an amide solvent exhibiting a high solubility for the polyamide-imide and (ii) a non-amide solvent in combination makes it possible to ensure a solubility, to obtain an excellent long-lasting application processability during application process, and further to suppress whitening caused by moisture absorption in an application process. The solvent used in the polyamide-imide solution of the present invention is a mixture solvent of an amide solvent and a non-amide solvent. The non-amide solvent is at least one solvent selected from the group consisting of ether solvents, ketone solvents, ester solvents, glycol ether solvents and glycol ester solvents. As the amide solvent, in view of solubility, it is preferable, to use N,N-dimethylacetamide or N,N-dimethylformamide (hereinafter, also referred to as DMF). The non-amide solvent is preferably a solvent selected from methyl ethyl ketone, methyl isobutyl ketone, cyclohexanone, cyclopentanone, propyleneglycol monomethylether acetate, methyl triglyme, methyl tetraglyme, methyl monoglyme, methyl diglyme, ethyl monoglyme, ethyl diglyme, butyl diglyme, and γ-butyrolactone. It is particularly preferable to use a solvent selected from cyclohexanone, cyclopentanone, propyleneglycol monomethylether acetate, and methyl triglyme, in view of the fact that these solvents each have a boiling point that does not largely differ from a boiling point of an amide solvent. Further, in view of improvement in whitening and less odor, it is preferable to use a symmetrical glycol diether solvent (glyme solvent) such as methyl triglyme, methyl tetraglyme, methyl monoglyme, methyl diglyme, ethyl monoglyme, ethyl diglyme, and butyl diglyme. Among these solvents, methyl triglyme is particularly preferable, in view of a smaller difference in boiling point from an amide solvent and in view of solubility for the polyamide-imide.

A mixture ratio of the amide solvent and the non-amide-solvent can be selected as appropriate within a range where transparency and uniformity of the polyamide-imide solution are maintained and whitening is suppressed. The mixture weight ratio, that is, a weight ratio (amide-solvent/non-amide solvent) of the amide solvent and the non-amide solvent is preferably in a range of 80/20 to 5/95, more preferably in a range of 80/20 to 10/90, much more preferably in a range of 70/30 to 20/80, and particularly preferably in a range of 70/30 to 30/70.

The viscosity of the polyamide-imide solution is selected as needed in accordance with a coating thickness and a coating environment and the viscosity is not specifically limited. The viscosity is preferably in a range of 0.1 Pa·s to 50 Pa·s, and more preferably in a range of 0.5 Pa·s to 30 Pa·s. In a case where the viscosity is less than 0.1 Pa·s, the viscosity of the solution is too low to ensure a sufficient preciseness in film thickness. On the other hand, in a case where the viscosity is more than 50 Pa·s, the viscosity of the solution is too high to ensure preciseness in film thickness. Moreover, such a high viscosity of more than 50 Pa·s may produce a portion that dries immediately after application of the solution and may result in a defect in appearance such as a defect caused by gel formation. In other words, a polyamide-imide solution viscosity of 0.1 Pa·s or more is preferable because a sufficient preciseness in film thickness can be ensured. Further, a polyamide-imide solution viscosity of 50 Pa·s or less is preferable because preciseness in film thickness can be ensured. Further, such a viscosity of 50 Pa·s or less suppresses the occurrence of a portion that dries immediately after application of the solution and as a result, a consequent defect in appearance such as gel deformity does not occur easily.

For example, in the polyamide-imide solution, a content of the polyamide-imide represented by the above general formula (1) is preferably in a range of 1% by weight to 50% by weight and more preferably, in a range of 7% by weight to 20% by weight. When the content is less than 1% by weight, it is difficult to stably obtain a uniform film. On the other hand, when the content is more than 50% by weight, the possibility of the occurrence of a problem in storage stability and/or the possibility of formation of a non-uniform film increases. Therefore, such a content in a range of less than 1% by weight or more than 50% by weight is not preferable. In other words, in the polyamide-imide solution, a content of the polyamide-imide is preferably in a range of 1% by weight or more and 50% by weight or less. When the content of the polyamide-imide presented by the above formula (1) is 1% by weight or more, an even film can be easily obtained. Meanwhile, when the content is 50% by weight or less, the possibility of the occurrence of a problem in storage stability and/or the possibility of formation of an uneven film becomes low.

Next, the following discusses the polyamide-imide film of the present invention. The polyamide-imide film of the present invention is a formed film containing a polyamide-imide including a structure represented by the above general formula (1). The polyamide-imide film of the present invention has a birefringence ΔN of 0.040 or higher, the birefringence being expressed by ΔN=Nxy−Nz, where an in-plane refractive index is Nxy and a refractive index in a thickness direction is Nz.

The film thickness of the polyamide-imide film of the present invention is preferably in a range of 5 μm to 100 μm, and more preferably in a range of 10 μm to 50 μm, in view of a sufficient film strength and easy handling. Further, because the film thickness affects the linear thermal expansion coefficient, the film thickness of the polyamide-imide film of the present invention is most preferably in a range of 15 μm to 40 μm in view of fulfilling both film strength and a low thermal expansion characteristic.

The following discusses a method for producing the polyamide-imide film of the present invention. The polyamide-imide film of the present invention can be obtained by forming a film from the polyamide-imide solution prepared by the above-described method. More specifically, the polyamide-imide film of the present invention is obtained by applying, onto a support, the polyamide-imide solution prepared by the above-described method. After this application of the polyamide-imide solution, a film is formed by drying and thereby, the polyamide-imide film can be obtained. By using the polyamide-imide solution of the present invention for film formation, self-alignment of polymer chains is induced. This develops a low linear thermal expansion characteristic. As to a drying temperature in film formation, any condition can be selected in accordance with a process. The drying temperature is not specifically limited.

The polyamide-imide film obtained by the above production method has, as film characteristics, a low linear thermal expansion characteristic and a dimensional stability before and after heating. For example, in a case where values of a linear thermal expansion characteristic and a dimensional stability are to be measured by a thermal mechanical analysis (TMA), a film thickness is measured and a film is cut into a film sample having a size of 10 mm×3 mm. Then, while a load of 3.0 g is being applied to this film sample, the values are measured at a temperature increase rate of 10° C./min. At this time, it is possible to obtain a polyamide-imide film whose linear thermal expansion coefficient at a temperature in a range of 100° C. to 300° C. is 22 ppm/K or less, more preferably 20 ppm/K or less, and much more preferably 15 ppm/K or less, and particularly preferably 13 ppm/K or less. The linear thermal expansion coefficient in the range of 100° C. to 300° C. is a value obtained by an evaluation method as described in “(3)

Linear thermal Expansion Coefficient of Film (Polyamide Film)”.

Further, the polyamide-imide film of the present invention has a value of the birefringence ΔN of 0.040 or more, the birefringence ΔN being expressed by an expression:

ΔN=Nxy−Nz,

where: an in-plane refractive index of the polyimide film is Nxy; and a refractive index of the polyamide-imide film in a thickness direction is Nz. Such a value of the birefringence ΔN is more preferably in a range of 0.070 or more and 0.30 or less, much more preferably in a range of 0.075 or more and 0.30 or less, particularly preferably in a range of 0.085 or more and 0.30 or less, and the most preferably, in a range of 0.085 or more and 0.20 or less. In a case where the value of the birefringence ΔN is less than 0.040, in-plane molecular orientation becomes insufficient and the linear thermal expansion coefficient becomes higher. Therefore, such a birefringence ΔN of less than 0.040 is not preferable. On the other hand, in a case were the value of the birefringence ΔN is more than 0.30, crystallization of the film occurs. This may result in a cloudy film. Therefore, such a birefringence ΔN of more than 0.30 is not preferable. In other words, in a case where the value of the birefringence ΔN is 0.040 or more, in-plane molecular orientation becomes sufficiently high and the linear thermal expansion coefficient becomes low. Therefore, the birefringence ΔN of 0.040 or more is preferable. In addition, in a case where the value of the birefringence ΔN is 0.30 or less, film crystallization does not easily occur and accordingly, the film does not easily become cloudy. Therefore, the birefringence ΔN of 0.30 or less is preferable.

When the polyamide-imide film is to be formed, the polyamide-imide solution is applied to a support. Examples of such a support used for formation of the polyamide-imide film are, for example: a glass substrate; a metal substrate or metal belt made of, for example, SUS; or a film made of a plastic selected from among polyethylene terephthalate, polycarbonate, polyacrylate, polyethylene naphthalate, triacetyl cellulose, and the like. However, the support is not limited to the above-described examples. In a case where a plastic film is used as the support, it is necessary to select as appropriate a plastic film made of a material that does not dissolve in the organic solvent used for dissolving the polyamide-imide.

It is preferable that the polyamide-imide film of the present invention has a glass transition temperature as high as possible, in view of heat resistance. The glass transition temperature is preferably 250° C. or higher at the time when measurement is carried out by differential scanning calorimetry (DSC) or dynamic mechanical analysis (DMA). The glass transition temperature of 300° C. or higher is more preferable because a higher heat processing temperature can be used.

The polyamide-imide of the present invention can be directly provided for a coating or formation process for producing a product or a component member. It is also possible to subject the polyamide-imide of the present invention formed into a film to processing such as coating so that a laminate is obtained. For providing the polyamide-imide of the present invention for a coating or formation process, it is possible to mix a photo-curable or thermosetting component, non-polymerizable binder resin other than the polyamide-imide of the present invention, and/or other component in production of the polyamide-imide solution of the present invention. Further, if necessary, it is possible to use the polyamide-imide of the present invention dissolved or dispersed in a solvent.

In order to give processing characteristics or various types of functionality to the polyamide-imide film of the present invention, it is also possible to mix any of other various organic or inorganic low-molecular compounds or other various organic or inorganic high-molecular compounds. For example, it is possible to mix a colorant, a surfactant, a leveling agent, a plasticizer, fine particles, a sensitizer, and/or the like. The fine particles encompass organic fine particles made of, for example, polystyrene and polytetrafluoroethylene and inorganic fine particles made of, for example, colloidal silica, carbon, or phyllosilicate, and the like. These fine particles may be porous or may have a hollow structure. Further, a function or a form of such a compound may be pigment, filler, fiber or the like.

The polyamide-imide solution and polyamide-imide film of the present invention each generally contains in general, 5.00% to 99.9% by weight of a solid content of the polyamide-imide including the structure represented by the general formula (1). Note that the expression “99.9% by weight” means “substantially all”. The solid content here indicates a substance obtained in a state where a content of a residual solvent is 0.1% by weight or less as a result of drying a solvent from a whole, that is, each of the polyamide-imide solution and the polyamide-imide film. A mixture ratio of an optional component is preferably in a range of 0.1% by weight to 50% by weight, more preferably in a range of 0.01% to 30% by weight, and most preferably 0.1% to 10% by weight with respect to an entire solid content. When the ratio is less than 0.01% by weight, it is difficult to obtain an effect of addition of an additive. On the other hand, when the ratio is more than 50% by weight, it is difficult to reflect a characteristic of the polyamide-imide in an end product. In other words, when a mixture ratio of the optional component is 0.1% by weight with respect to a whole solid content, an effect of addition of an additive can be obtained. Therefore, the mixture ratio of 0.1% by weight is preferable. Further, when the mixture ratio is 50% by weight or less, the characteristic of the polyamide-imide tends to be reflected in an end product. Therefore, the mixture ratio of 50% by weight or less is preferable. Note that the solid content of the polyamide-imide indicates all components except solvent. Therefore, the solid content encompasses a liquid monomer component.

The polyamide-imide solution of the present invention is formed into a film. Then, on a surface of the film, any of various types of inorganic thin films such as a metal oxide film and a transparent electrode film may be formed. A method for forming such a film is not specifically limited but may be, for example, a CVD method; or a PVD method such as a sputtering method, a vapor deposition method, or an ion plating method.

The polyamide-imide solution of the present invention has a high dimensional stability and a high solubility in an organic solvent, in addition to characteristics, such as heat resistance, insulating property, and the like, that are inherent in polyamide-imide. Further, the polyamide-imide solution of the present invention is excellent in coating applicability. Therefore, the polyamide-imide solution of the present invention can be suitably employed in fields or products in which the above-described characteristics are effective. Examples of such fields or products are: optical materials such as a printed matter, a color filter, a flexible display substrate, a TFT substrate, an optical film, and the like; an image display device such as a liquid crystal display device, an organic EL, and the electronic paper; an electronic device material; and solar cells. Further, the polyamide-imide solution of the present invention can also be applied as a replacement material for a portion for which glass is currently used.

In other words, the invention of the subject application has the following arrangements.

1. A polyamide-imide solution including: an organic solvent; and a polyamide-imide including a structure represented by the following general formula (1), the organic solvent being a mixture solvent of an amide solvent and a non-amide solvent, the non-amide solvent being at least one solvent selected from the group consisting of ether solvents, ketone solvents, ester solvents, glycol ether solvents, and glycol ester solvents.

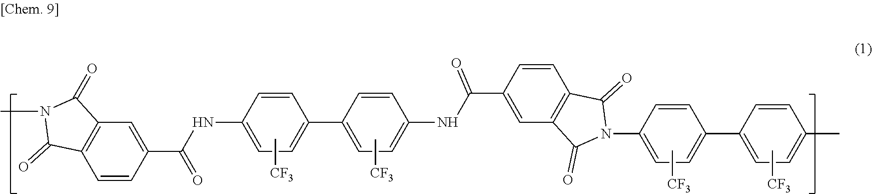

More preferably, a polyamide-imide solution including: an organic solvent; and a polyamide-imide represented by the above general formula (1), the organic solvent being a mixture solvent of an amide solvent and a non-amide solvent, the non-amide solvent being at least one solvent selected from the group consisting of ether solvents, ketone solvents, ester solvents, glycol ether solvents, and glycol ester solvents.

2. The polyamide-imide solution as set forth in 1, wherein a weight ratio of the amide solvent and the non-amide solvent (amide solvent/non-amide solvent) is in a range of 80/20 to 5/95.

More preferably, the polyamide-imide solution as set forth in claim 1, wherein a weight ratio of the amide solvent and the non-amide solvent (amide solvent/non-amide solvent) is in a range of 80/20 to 10/90.

3. The polyamide-imide solution as set forth in 1 or 2, wherein: the polyamide-imide including the structure represented by the general formula (1) is a polyamide-imide represented by the general formula (6).

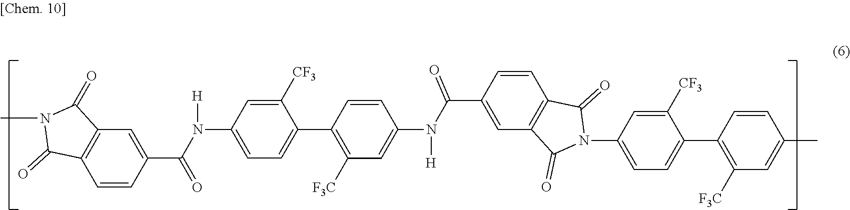

4. The polyamide-imide solution as set forth in any one of 1 to 3, wherein: the amide solvent is N,N-dimethylacetamide or N,N-dimethylformamide; and the non-amide solvent is at least one solvent selected from the group consisting of methyl ethyl ketone, methyl isobutyl ketone, cyclohexanone, cyclopentanone, propyleneglycol monomethylether acetate, methyl triglyme, methyl tetraglyme, methyl monoglyme, methyl diglyme, ethyl monoglyme, ethyl diglyme, butyl diglyme, and γ-butyrolactone.

More preferably, the polyamide-imide solution as set forth in any one of 1 to 3, wherein: the amide solvent is N,N-dimethylacetamide or N,N-dimethylformamide; and the non-amide solvent is at least one solvent selected from the group consisting of methyl ethyl ketone, methyl isobutyl ketone, cyclohexanone, cyclopentanone, propyleneglycol monomethylether acetate, and methyl triglyme.

5. A polyamide-imide film including a polyamide-imide including a structure represented by the general formula (1):

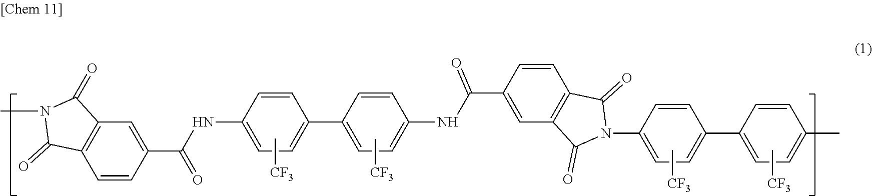

the polyamide-imide film having a birefringence ΔN of 0.040 or higher, the birefringence being expressed by ΔN=Nxy−Nz, where an in-plane refractive index is Nxy and a refractive index in a thickness direction is Nz.

6. A polyamide-imide film obtained by forming a film from a polyamide-imide solution as set forth in any one of the above 1 to 4.

7. The polyamide-imide film as set forth in 5, obtained by forming a film from a polyamide-imide solution, the polyamide-imide solution including: an organic solvent; and a polyamide-imide including a structure represented by the general formula (1), the organic solvent being a mixture solvent of an amide solvent and a non-amide solvent, the non-amide solvent being at least one solvent selected from the group consisting of ether solvents, ketone solvents, ester solvents, glycol ether solvents, and glycol ester solvents.

8. The polyamide-imide film as set forth in 6 or 7, obtained by applying the polyamide-imide solution onto a support.

9. The polyamide-imide film as set forth in any one of 5 to 8, having a linear thermal expansion coefficient of 22 ppm/K or less at a temperature in a range of 100° C. to 300° C. More preferably, the polyamide-imide film as set forth in any one of 5 to 8, having a linear thermal expansion coefficient of 20 ppm/K or less at a temperature in a range of 100° C. to 300° C.

10. The polyamide-imide film as set forth in any one of 5 to 9 wherein: the birefringence ΔN is 0.070 or more and 0.30 or less, the birefringence ΔN being expressed by ΔN=Nxy−Nz, where Nxy is an in-plane refractive index and Nz is an refractive index.

11. A laminate including: a polyamide-imide film as set forth in any one of 5 to 10 above; and a glass substrate.

12. A flexible display substrate including a polyamide-imide film as set forth in any one of 5 to 10 above.

13. A TFT substrate including a polyamide-imide film as set forth in any one of 5 to 10 above.

14. A color filter including a polyamide-imide film as set forth in any one of 5 to 10 above.

15. An electronic paper including a polyamide-imide film as set forth in any one of 5 to 10 above.

16. An organic EL display including a polyamide-imide film as set forth in any one of 5 to 10 above.

### EXAMPLES

### Evaluation Method

The following evaluation method is used for obtaining material characteristic values described in the present specification.

(1) Molecular Weight of Polyamide-Imide

Under conditions shown in Table 1, weight-average molecular weights (Mw) were obtained. Table 3 shows an evaluation result.

TABLE 1

| | Conditions of |
|---|---|
| Item | Apparatus for Molecular Weight Measurement |
| Apparatus | CO-8020, SD-8022, DP-8020, AS-8020, RI- |
| | 8020 |
| | (all manufactured by Tosoh Corporation) |
| Column | Shodex: GPC KD-806M × 2 |
| Column Size | each 8 mmΦ × 30 cm, total 60 cm |
| | guard column (GPC KD-G) 4.6 mmΦ × 1 cm |
| Column | 40° C. |
| Temperature | |
| Eluent | 30 mM-LiBr + 30 mM-phosphoric acid |
| | DMF |
| Flow Rate | 0.6 mL/min |
| Inlet | approximately 1.3 to 1.7 MPa |
| Pressure | |
| Inlet Volume | 30 μL (solid content concentration 0.4 wt %) |
| Reference | polyethylene oxide |
| Sample | (used for creation of calibration curve) |
| Detector | RI |
| Order of | 1st Order |
| Calibration | |
| Curve | |

(2) Solubility Test of Polyamide-imide into Organic Solvent and Odor Evaluation of Organic Solvent

With respect to 0.5 g of polyamide-imides respectively obtained in Synthesis Examples 1, 2, and 3, 9.5 g of one of organic solvents (solid content concentration 5%) shown in Table 2 was mixed in a sample tube, and a resultant mixture was stirred at a room temperature, more specifically, at 23° C. by a magnetic stirrer. Then, an organic solvent in which the polyamide-imide was completely dissolved was evaluated as “Good”; an organic solvent in which the polyamide-imide partially remained undissolved was evaluated as “Fair”; and an organic solvent in which the polyamide-imide was insoluble was evaluated as “Poor”. Table 2 shows solvents used in the evaluation, respective boiling points of the solvents, and a result of the evaluation. Further, odor of the organic solvents was evaluated. An organic solvent that had substantially no odor was evaluated as “Good”; an organic solvent that had light odor was evaluated as “Fair”; and an organic solvent that had distinct odor was evaluated as “Poor”. Table 2 shows a result of this evaluation. Further, organic solvents (including mixture solvents) used in Examples and Comparative Examples of the present invention were similarly evaluated. Table 3 shows a result of this evaluation.

TABLE 2

| | Boiling | Solubility | | | |
|---|---|---|---|---|---|
| | Point | Synthesis | Synthesis | Synthesis | |
| Solvent | (° C.) | Example 1 | Example 2 | Example 3 | Odor |
| Tetrahydrofuran | 65 | Good | Good | Good | Poor |
| 1,3-dioxolan | 75 | Good | Good | Good | Poor |
| 1,4-dioxane | 101 | Good | Good | Good | Fair |
| Cyclopentanone | 130 | Good | Good | Good | Poor |
| Cyclohexanone | 155 | Fair | Fair | Fair | Poor |
| Ethyl acetate | 77 | Fair | Fair | Fair | Poor |
| γ-butyrolactone | 204 | Fair | Poor | Poor | Good |
| NMP | 202 | Fair | Fair | Fair | Fair |
| DMF | 151 | Good | Good | Good | Fair |
| DMAC | 166 | Good | Good | Good | Fair |
| Methyltriglyme | 216 | Good | Fair | Good | Good |

(3) Linear Thermal Expansion Coefficient of Film (Polyamide-Imide Film)

The linear thermal expansion coefficient was measured as follows, by using TMA120C manufactured by Seiko Electronics Industrial Co., Ltd. (sample size: 3 mm (width) by 10 mm (length); TMA120C measures a thickness of the sample and calculates a film cross sectional area). First, a temperature was increased (first temperature increase) at 10° C./min from 10° C. up to 340° C. under the load of 3 g. Then, the temperature was decreased to 10° C. Further, the temperature was increased (second temperature increase) at 10° C./min up to 340° C. again. From an amount of change in deformation of a sample for each of (a) a unit temperature from 100° C. to 200° C. and (b) a unit temperature from 100° C. to 300° C. in the second temperature increase, the linear thermal expansion coefficient was obtained.

(4) Glass Transition Temperature of Film

By using DMS-200 manufactured by Seiko Electronics Industrial Co., Ltd., a dynamic viscoelasticity was measured under a condition in which a length for measurement (measurement jig interval) was set at 20 mm and a frequency for measurement was set at 1 Hz. Then, an inflection point (a peak top of tan 6) of a storage elastic modulus was taken as a glass transition temperature.

(5) Birefringence of Film (Polyamide-Imide Film)

As an index indicating a degree (in-plane orientation degree) at which high molecular chains are oriented in parallel to a film surface, a birefringence was measured. Here, the birefringence (ΔN) is a value expressed by ΔN=Nxy−Nz, where: Nxy is an in-plane refractive index of the polyamide-imide film; and Nz is a refractive index in a thickness direction. The refractive index was measured by using Abbe refractometer (DR-M2) (manufactured by ATAGO Co., Ltd.) where an eyepiece with a polarizer was set. In this measurement, on a film that was cut so as to have a size of 40 mm×8 mm was measured. A polarization direction was changed by altering a direction of the polarizer, so that both the in-plane refractive index and the refractive index in the thickness direction were measured. In the measurement, a wavelength for the measurement was a wavelength of a sodium lamp (589 nm) that was used as a light source; an intermediate liquid was sulfur saturated methylene iodide; and a test piece had a refractive index of 1.92.

(6) Evaluation of Whitening in Application Process

The polyamide-imide solution was applied onto a glass substrate that was a support so as to prepare a wet film. This wet film was observed in an environment at a temperature of 23° C. and a relative humidity of 55% RH, and a time (time before whitening) elapsed before whitening of the wet film started was measured. In a case where the time elapsed before whitening started was equal to or longer than 5 minutes, it was judged that whitening in an application process was suppressed.

(7) Tack-Free Evaluation

The polyamide-imide solution was applied onto a glass substrate that was a support so as to prepare a wet film. This wet film was observed in an environment at a temperature of 23° C. and a relative humidity of 55% RH, and a time elapsed before a surface dried and a tack-free state was established was measured. In a case where thus measured time was equal to or longer than 10 minutes, it was judged that long-lasting application processability during application process was preferable.

### Synthesis Example 1

### Synthesis of Polyamide-Imide

In a 2 L glass separable flask equipped with (i) a stirrer including a stainless-steel stirring rod with an impeller provided to a polytetrafluoroethylene sealing plug and (ii) a nitrogen inlet tube, 12.1 g of 2,2′-bis(trifluoromethyl)benzidine (hereinafter, also referred to as TFMB) was introduced. To this TFMB, 46.6 g of dehydrated N,N-dimethylacetamide (DMAC) was added as a solvent for polymerization and stirring was carried out. Further, 3.0 g of pyridine was added and then, thus obtained solution was stirred until a uniform solution was obtained. Then, the solution was cooled in an ice bath at 5° C. While the solution was being stirred, 7.9 g of trimellitic anhydride chloride powder was slowly added and then 3-hour stirring was carried out in an ice bath at 5° C. Note that a concentration of solutes in thus obtained solution, that is, a concentration of a diamine compound and trimellitic anhydride chloride added in the solution was 30% by weight with respect to a whole reaction solution.

After the 3-hour stirring, the solution was diluted by addition of 33.4 g of DMAC into the solution. Then, after 20-hour stirring was carried out in a water bath at 25° C., 33.3 g of DMAC was further added. Then, stirring was carried out until this DMAC was uniformly dissolved. Subsequently, 6.0 g of pyridine was added as an imidization catalyst and dispersed completely. Into thus obtained solution, 9.2 g of acetic anhydride was added and stirring was carried out. Subsequently, 4-hour stirring was carried out at 100° C., and then the solution was cooled down to a room temperature (23° C.). To thus cooled solution, 33.3 g of DMAC was further added and stirring was carried out. While the solution was kept being stirred, 350 g of 2-propyl alcohol (hereinafter, IPA) was added at a rate of 2 to 3 drops/sec by use of a dropping funnel. As a result, a target product was precipitated. Then, suction filtration was carried out with use of Kiriyama rohto (funnel) and the target product was washed 5 times repeatedly with 200 g of IPA. Thereafter, the target product was dried for 12 hours in a vacuum oven set at 120° C. As a result, the target product was obtained at a yield of 17.0 g.

### Example 1

### Preparation of Film

The polyamide-imide obtained in Synthesis Example 1 was dissolved in a mixture solvent of DMAC and cyclopentanone (hereinafter, CPN) at a weight ratio of DMAC/CPN=70/30, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 2

The polyamide-imide obtained in Synthesis Example 1 was dissolved in a mixture solvent of DMAC and CPN at a weight ratio of DMAC/CPN=50/50, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 3

The polyamide-imide obtained in Synthesis Example 1 was dissolved in a mixture solvent of DMAC and cyclohexanone (hereinafter, CHN) at a weight ratio of DMAC/CHN=70/30, and thereby a polyamide-imide solution containing 10% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 4

The polyamide-imide obtained in Synthesis Example 1 was dissolved in a mixture solvent of DMAC and CHN at a weight ratio of DMAC/CHN=50/50, and thereby a polyamide-imide solution containing 10% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 5

The polyamide-imide obtained in Synthesis Example 1 was dissolved in a mixture solvent of DMAC and propyleneglycol monomethylether acetate (hereinafter, PGMEA) at a weight ratio of DMAC/PGMEA=70/30, and thereby a polyamide-imide solution containing 10% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 6

The polyamide-imide obtained in Synthesis Example 1 was dissolved in a mixture solvent of DMF and CPN at a weight ratio of DMF/CPN=50/50, and thereby a polyamide-imide solution containing 10% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 7

The polyamide-imide obtained in Synthesis Example 1 was dissolved in a mixture solvent of DMF and CHN at a weight ratio of DMF/CHN=50/50, and thereby a polyamide-imide solution containing 10% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Synthesis Example 2

### Synthesis of Amide-Group-Containing Tetracarboxylic Dianhydride (Formula (7) Below)

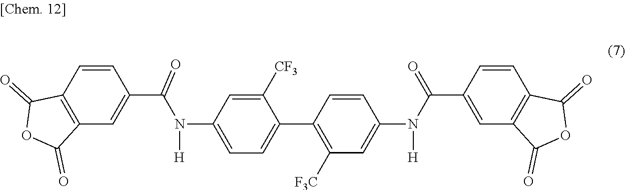 [SMILES: O=C(Nc1ccc(-c2ccc(NC(=O)c3ccc4c(c3)C(=O)OC4=O)cc2C(F)(F)F)c(C(F)(F)F)c1)c1ccc2c(c1)C(=O)OC2=O]

In a 500 mL glass separable flask equipped with (i) a stirrer including a stainless-steel stirring rod with a four-blade impeller provided to a polytetrafluoroethylene sealing plug and (ii) a nitrogen inlet tube, 67.4 g of trimellitic anhydride chloride was introduced. Then, a mixture solvent including 190 g of ethyl acetate and 190 g of n-hexane was added and the trimellitic anhydride chloride was dissolved, so that a solution A was prepared. Further, in another container, 25.6 g of 2,2′-bis(trifluoromethyl)benzidine (TFMB) was provided and a mixture solvent including 72 g of ethyl acetate and 72 g of n-hexane was added, so that the TFMB was dissolved in the mixture solvent. Further, 9.2 g of propylene oxide was added as a deoxidizer and thereby, a solution B was prepared.

To the solution A whose temperature was lowered to approximately −20° C. in an ethanol ice bath, the solution B was dropped under stirring. Then, 3-hour stirring was carried out. Subsequently, thus obtained solution was stirred for 12 hours at a room temperature (23° C.). A resultant precipitate was separated by filtration and washed well with an ethyl acetate/n-hexane mixture solvent (volume ratio: 1:1). Thereafter, separation by filtration was carried out again and vacuum dehydration was carried out first at 60° C. for 12 hours, and then at 120° C. for 12 hours. Thereby, a resultant white product was obtained at a yield of 70%. By FT-IR and ¹H-NMR, it was confirmed that an amide-group-containing tetracarboxylic dianhydride represented by the formula (7), which was a target product, was obtained. Specifically, it was possible to observe (i) by FT-IR, peaks at 3380 cm⁻¹ (amide group NH stretching vibration), 3105 cm⁻¹ (aromatic C—H stretching vibration), 1857 cm⁻¹ and 1781 cm⁻¹ (acid anhydride group C═O stretching vibration), and 1677 cm⁻¹ (amide group C═O stretching vibration) and (ii) by ¹H-NMR, peaks at 611.06 ppm (s, NH, 2H), 68.65 ppm (s, on phthalic anhydride, 3-position CₐᵣₒₘH, 2H), 68.37 ppm (5,6-position CₐᵣₒₘH on phthalic anhydride, 4H), 67.46 ppm (d, on central biphenyl, 6,6′-position CₐᵣₒₘH, 2H), 68.13 ppm (d, on central biphenyl, 5,5′-position CₐᵣₒₘH, 2H), and 68.27 ppm (s, on central biphenyl, 3,3′-position CₐᵣₒₘH, 2H); this proves that the amide-group-containing tetracarboxylic dianhydride as represented by the above formula (7) was obtained. As a result of measurement of a melting point of this compound by DSC, the melting point of this compound was found to be 274° C.

### Synthesis of Polyamide-Imide

In a 500 mL glass separable flask equipped with (i) a stirrer including a stainless-steel stirring rod with a four-blade impeller provided to a polytetrafluoroethylene sealing plug and (ii) a nitrogen inlet tube, 9.7 g of TFMB was introduced. Then, 153 g of dehydrated N,N-dimethylformamide (DMF) was added as a solvent for polymerization. After thus obtained solution was stirred, 20.2 g of the amide-group-containing tetracarboxylic dianhydride as represented by the above formula (7) was added to the solution. After 10-minute stirring, 17 g of acetic acid was added. Then, stirring at a room temperature (23° C.) was carried out and thereby, polyamide-amide acid was obtained. Note that in thus obtained solution, a concentration of a diamine compound and tetracarboxylic dianhydride added in the solution was 15% by weight with respect to a whole reaction solution.

After 24-hour stirring, 4.8 g of pyridine was added as an imidization catalyst and completely dispersed. Into thus obtained solution, 7.4 g of acetic anhydride was added and stirring was carried out. Then, after 4-hour stirring was carried out at 100° C., a resultant solution was cooled down to the room temperature (23° C.). Into this solution, 88 g of DMF was added and stirring was carried out. Thus obtained solution was transferred to a 2 L separable flask. Into the solution, 600 g of IPA was further added at a rate of 2 to 3 drops/sec. Thereby, a target product was precipitated. Then, suction filtration was carried out with use of Kiriyama rohto (funnel) and the target product was washed 2 times repeatedly with 300 g of IPA. Thereafter, the target product was dried overnight in a vacuum oven set at 100° C. As a result, the target product was obtained at a yield of 28.5 g.

### Example 8

### Preparation of Film

The polyamide-imide obtained in Synthesis Example 2 was dissolved in a mixture solvent of DMAC and CPN at a weight ratio of DMAC/CPN=70/30, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 9

The polyamide-imide obtained in Synthesis Example 2 was dissolved in a mixture solvent of DMAC and CPN at a weight ratio of DMAC/CPN=50/50, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 10

The polyamide-imide obtained in Synthesis Example 2 was dissolved in a mixture solvent of DMAC and CHN at a weight ratio of DMAC/CHN=70/30, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 11

The polyamide-imide obtained in Synthesis Example 2 was dissolved in a mixture solvent of DMAC and CHN at a weight ratio of DMAC/CHN=50/50, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 12

The polyamide-imide obtained in Synthesis Example 2 was dissolved in a mixture solvent of DMAC and PGMEA at a weight ratio of DMAC/PGMEA=70/30, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 13

The polyamide-imide obtained in Synthesis Example 2 was dissolved in a mixture solvent of DMF and CPN at a weight ratio of DMF/CPM=50/50, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 14

The polyamide-imide obtained in Synthesis Example 2 was dissolved in a mixture solvent of DMF and CHN at a weight ratio of DMF/CHN=50/50, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 15

The polyamide-imide obtained in Synthesis Example 1 was dissolved in a mixture solvent of DMAC and methyltriglyme (hereinafter, MTG) at a weight ratio of DMAC/MTG=20/80, and thereby a polyamide-imide solution containing 7% by weight of polyamide-imide was prepared. After applying this polyamide-imide solution on a glass plate that was a support, dehydration was carried out f first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Synthesis Example 3

### Synthesis of Polyamide-Imide

In a 500 mL glass separable flask equipped with (i) a stirrer including a stainless-steel stirring rod with a four-blade impeller provided to a polytetrafluoroethylene sealing plug and (ii) a nitrogen inlet tube, 9.8 g of TFMB was introduced. Then, 153 g of dehydrated N,N-dimethylformamide (DMF) was added as a solvent for polymerization. After thus obtained solution was stirred, 20.1 g of the amide-group-containing tetracarboxylic dianhydride as represented by the above formula (7) was added to the solution. After 10-minute stirring, 17 g of acetic acid was added. Then, stirring at a room temperature (23° C.) was carried out and thereby, polyamide-amide acid was obtained. Note that in thus obtained solution, a concentration of a diamine compound and tetracarboxylic dianhydride added in the solution was 15% by weight with respect to a whole reaction solution.

After 24-hour stirring, 4.8 g of pyridine was added as an imidization catalyst and completely dispersed. Into thus obtained solution, 7.4 g of acetic anhydride was added and stirring was carried out. Then, after 4-hour stirring was carried out at 100° C., a resultant solution was cooled down to the room temperature (23° C.). Into this solution, 88 g of DMF was added and stirring was carried out. Thus obtained solution was transferred to a 2 L separable flask. Into the solution, 600 g of IPA was further added at a rate of 2 to 3 drops/sec. Thereby, a target product was precipitated. Then, suction filtration was carried out with use of Kiriyama rohto (funnel) and the target product was washed 2 times repeatedly with 300 g of IPA. Thereafter, the target product was dried overnight in a vacuum oven set at 100° C. As a result, the target product was obtained at a yield of 28.5 g.

### Example 16

The polyamide-imide obtained in Synthesis Example 3 was dissolved in a mixture solvent of DMAC and MTG at a weight ratio of DMAC/MTG=30/70, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Example 17

The polyamide-imide obtained in Synthesis Example 3 was dissolved in a mixture solvent of DMAC and γ-butyrolactone (GBL) at a weight ratio of DMAC/GBL=50/50, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 1

The polyamide-imide obtained in Synthesis Example 1 was dissolved in DMAC and thereby a polyamide-imide solution containing 10% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 2

The polyamide-imide obtained in Synthesis Example 1 was dissolved in DMF, and thereby a polyamide-imide solution containing 10% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 3

The polyamide-imide obtained in Synthesis Example 1 was dissolved in tetrahydrofuran (hereinafter, THF), and thereby a polyamide-imide solution containing 10% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 4

The polyamide-imide obtained in Synthesis Example 1 was dissolved in 1,3-dioxolan, and thereby a polyamide-imide solution containing 10% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 5

The polyamide-imide obtained in Synthesis Example 1 was dissolved in 1,4-dioxane, and thereby a polyamide-imide solution containing 10% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 6

The polyamide-imide obtained in Synthesis Example 2 was dissolved in DMAC, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 7

The polyamide-imide obtained in Synthesis Example 2 was dissolved in DMF and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 8

The polyamide-imide obtained in Synthesis Example 2 was dissolved in THF and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 9

The polyamide-imide obtained in Synthesis Example 2 was dissolved in 1,3-dioxolan and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 10

The polyamide-imide obtained in Synthesis Example 2 was dissolved in 1,4-dioxane and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Synthesis Example 4

In a 500 mL glass separable flask equipped with (i) a stirrer including a stainless-steel stirring rod with a four-blade impeller provided to a polytetrafluoroethylene sealing plug and (ii) a nitrogen inlet tube, 9.7 g of TFMB was introduced. Then, 170 g of dehydrated N,N-dimethylformamide (DMF) was added as a solvent for polymerization. After thus obtained solution was stirred, 20.2 g of the amide-group-containing tetracarboxylic dianhydride as represented by the above formula (7) was added. Then, stirring at a room temperature (23° C.) was carried out and thereby, polyamide-amide acid was obtained. Note that in thus obtained solution, a concentration of a diamine compound and tetracarboxylic dianhydride added in the solution was 15% by weight with respect to a whole reaction solution. To this reaction solution, 100 g of DMF was added so that a concentration of DMF added was adjusted to be 10% by weight. Thereby, polyamide-amide acid was obtained.

### Comparative Example 11

### Preparation of Film

The polyamide-amide acid solution obtained in Synthesis Example 4 was applied on a glass plate that was a support. Further, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 12

The polyamide-imide film obtained in Comparative Example 11 was dissolved again in DMAC, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 13

The polyamide-imide obtained in Synthesis Example 1 was dissolved in MTG, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Comparative Example 14

The polyamide-imide obtained in Synthesis Example 2 was dissolved in a mixture solvent of DMAC and DMF at a weight ratio of DMAC/DMF=50/50, and thereby a polyamide-imide solution containing 7% by weight of polyamide-imide was prepared. After applying this polyamide-imide solution on a glass plate that was a support, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

### Synthesis Example 5

In a 500 mL glass separable flask equipped with (i) a stirrer including a stainless-steel stirring rod with a four-blade impeller provided to a polytetrafluoroethylene sealing plug and (ii) a nitrogen inlet tube, 9.7 g of TFMB was introduced. Then, 170 g of dehydrated DMAC was added as a solvent for polymerization. After thus obtained solution was stirred, 20.4 g of the amide-group-containing tetracarboxylic dianhydride as represented by the above formula (7) was added. Then, stirring at a room temperature (23° C.) was carried out and thereby, polyamide-amide acid was obtained. Note that in thus obtained solution, a concentration of a diamine compound and tetracarboxylic dianhydride added in the solution was 15% by weight with respect to a whole reaction solution. To this reaction solution, 100 g of DMAC was added so that a concentration of DMAC added was adjusted to be 10% by weight. Thereby, polyamide-amid acid was obtained.

### Comparative Example 15

The polyamide-amide acid solution obtained in Synthesis Example 5 was applied on a glass plate that was a support. Further, dehydration was carried out first at 60° C. for 10 minutes, then at 150° C. for 60 minutes, and further at 300° C. for 60 minutes. Then, a film was obtained by peeling the film off from the glass plate. Table 3 shows an evaluation result of thus obtained film.

TABLE 3

| | | | | | Molecular | |
|---|---|---|---|---|---|---|
| | Synthesis | | | | Weight | Film Thickness |
| | Examples | Solvent 1 | Solvent 2 | Solvent 1/Solvent 2 | (Mw) | (μm) |
| Example 1 | Synthesis | DMAC | CPN | 70/30 | 100,000 | 30 |
| | Example 1 | | | | | |
| Example 2 | Synthesis | DMAC | CPN | 50/50 | 100,000 | 31 |
| | Example 1 | | | | | |
| Example 3 | Synthesis | DMAC | CHN | 70/30 | 100,000 | 29 |
| | Example 1 | | | | | 20 |
| Example 4 | Synthesis | DMAC | CHN | 50/50 | 100,000 | 30 |
| | Example 1 | | | | | 20 |
| Example 5 | Synthesis | DMAC | PGMEA | 70/30 | 100,000 | 30 |
| | Example 1 | | | | | |
| Example 6 | Synthesis | DMF | CPN | 50/50 | 100,000 | 28 |
| | Example 1 | | | | | |
| Example 7 | Synthesis | DMF | CHN | 50/50 | 100,000 | 28 |
| | Example 1 | | | | | |
| Example 8 | Synthesis | DMAC | CPN | 70/30 | 150,000 | 27 |
| | Example 2 | | | | | |
| Example 9 | Synthesis | DMAC | CPN | 50/50 | 150,000 | 28 |
| | Example 2 | | | | | |
| Example 10 | Synthesis | DMAC | CHN | 70/30 | 150,000 | 27 |
| | Example 2 | | | | | 20 |
| Example 11 | Synthesis | DMAC | CHN | 50/50 | 150,000 | 27 |
| | Example 2 | | | | | 20 |
| Example 12 | Synthesis | DMAC | PGMEA | 70/30 | 150,000 | 28 |
| | Example 2 | | | | | |
| Example 13 | Synthesis | DMF | CPN | 50/50 | 150,000 | 29 |
| | Example 2 | | | | | |
| Example 14 | Synthesis | DMF | CHN | 50/50 | 150,000 | 29 |
| | Example 2 | | | | | |
| Example 15 | Synthesis | DMAC | MTG | 20/80 | 100,000 | 30 |
| | Example 1 | | | | | 20 |
| Example 16 | Synthesis | DMAC | MTG | 30/70 | 130,000 | 30 |
| | Example 3 | | | | | 20 |
| Example 17 | Synthesis | DMAC | GBL | 50/50 | 130,000 | 30 |
| | Example 3 | | | | | |
| Comparative | Synthesis | DMAC | — | — | 100,000 | 30 |
| Example 1 | Example 1 | | | | | |
| Comparative | Synthesis | DMF | — | — | 100,000 | 30 |
| Example 2 | Example 1 | | | | | |
| Comparative | Synthesis | THF | — | — | 100,000 | 30 |
| Example 3 | Example 1 | | | | | |
| Comparative | Synthesis | 1,3- | — | — | 100,000 | 30 |
| Example 4 | Example 1 | dioxolane | | | | |
| Comparative | Synthesis | 1,4- | — | — | 100,000 | 30 |
| Example 5 | Example 1 | dioxane | | | | |
| Comparative | Synthesis | DMAC | — | — | 150,000 | 30 |
| Example 6 | Example 2 | | | | | |
| Comparative | Synthesis | DMF | — | — | 150,000 | 28 |
| Example 7 | Example 2 | | | | | |
| Comparative | Synthesis | THF | — | — | 150,000 | 30 |
| Example 8 | Example 2 | | | | | |
| Comparative | Synthesis | 1,3- | — | — | 150,000 | 30 |
| Example 9 | Example 2 | dioxolane | | | | |
| Comparative | Synthesis | 1,4- | — | — | 150,000 | 30 |
| Example 10 | Example 2 | dioxane | | | | |
| Comparative | Synthesis | DMF | — | — | 130,000 | 32 |
| Example 11 | Example 4 | | | | | |
| Comparative | Synthesis | DMAC | — | — | 130,000 | 31 |
| Example 12 | Example 4 | | | | | |
| Comparative | Synthesis | MTG | — | — | 100,000 | 20 |
| Example 13 | Example 1 | | | | | |
| Comparative | Synthesis | DMAC | DMF | 50/50 | 150,000 | 30 |
| Example 14 | Example 2 | | DMF | 50/50 | 150,000 | 20 |
| Comparative | Synthesis | DMAC | — | — | 160,000 | 30 |
| Example 15 | Example 5 | | | | | |

| | Linear Thermal | | | | | | |
|---|---|---|---|---|---|---|---|
| | Expansion | | | | | | |
| | Coefficient | | | Glass | | | |
| | (CTE) | | | Transition | Time | | |
| | 100-200° C. | 100-300° C. | In-plane | Temperature | before | Tack- | |
| | (ppm/ | (ppm/ | Birefringence | Tg | Whitening | free | |
| | K) | k) | ΔN | (° C.) | min | min | Odor |
| Example 1 | 15 | 22 | 0.080 | 350 | 15 | 50 | Poor |
| Example 2 | 14 | 20 | 0.081 | 350 | 20 | 45 | Poor |
| Example 3 | 15 | 20 | 0.080 | 350 | 15 | 50 | Poor |
| | 10 | 15 | 0.080 | 350 | 15 | 50 | Poor |
| Example 4 | 14 | 20 | 0.081 | 350 | 20 | 45 | Poor |
| | 10 | 15 | 0.081 | 350 | 20 | 45 | Poor |
| Example 5 | 13 | 19 | 0.082 | 350 | 10 | 50 | Poor |
| Example 6 | 15 | 22 | 0.080 | 350 | 20 | 45 | Poor |
| Example 7 | 15 | 21 | 0.080 | 350 | 20 | 45 | Poor |
| Example 8 | 7 | 10 | 0.090 | 350 | 15 | 50 | Poor |
| Example 9 | 8 | 12 | 0.090 | 350 | 20 | 45 | Poor |
| Example 10 | 8 | 10 | 0.093 | 350 | 15 | 50 | Poor |
| | 7 | 10 | 0.093 | 350 | 15 | 50 | Poor |
| Example 11 | 8 | 11 | 0.092 | 350 | 20 | 45 | Poor |
| | 7 | 10 | 0.092 | 350 | 20 | 45 | Poor |
| Example 12 | 8 | 12 | 0.090 | 350 | 10 | 50 | Poor |
| Example 13 | 8 | 12 | 0.091 | 350 | 20 | 60 | Poor |
| Example 14 | 8 | 12 | 0.090 | 350 | 20 | 60 | Poor |
| Example 15 | 15 | 22 | 0.075 | 350 | 60 | 60 | Good |
| | 14 | 20 | 0.075 | 350 | 60 | 60 | Good |
| Example 16 | 14 | 20 | 0.080 | 350 | 60 | 60 | Good |
| | 13 | 18 | 0.080 | 350 | 60 | 60 | Good |
| Example 17 | 10 | 15 | 0.081 | 350 | 5 | 60 | Good |
| Comparative | 15 | 22 | 0.078 | 350 | 2 | 60 | Fair |
| Example 1 | | | | | | | |
| Comparative | 15 | 22 | 0.078 | 350 | 2 | 60 | Fair |
| Example 2 | | | | | | | |
| Comparative | 9 | 13 | 0.090 | 350 | 15 | 5 | Poor |
| Example 3 | | | | | | | |
| Comparative | 9 | 13 | 0.088 | 350 | 15 | 7 | Poor |
| Example 4 | | | | | | | |
| Comparative | 9 | 13 | 0.090 | 350 | 20 | 9 | Fair |
| Example 5 | | | | | | | |
| Comparative | 9 | 12 | 0.088 | 350 | 3 | 60 | Fair |
| Example 6 | | | | | | | |
| Comparative | 9 | 12 | 0.089 | 350 | 3 | 60 | Fair |
| Example 7 | | | | | | | |
| Comparative | 7 | 10 | 0.095 | 350 | 15 | 5 | Poor |
| Example 8 | | | | | | | |
| Comparative | 7 | 11 | 0.094 | 350 | 15 | 7 | Poor |
| Example 9 | | | | | | | |
| Comparative | 7 | 11 | 0.094 | 350 | 20 | 9 | Fair |
| Example 10 | | | | | | | |
| Comparative | 38 | 55 | 0.024 | 350 | 5 | 60 | Fair |
| Example 11 | | | | | | | |
| Comparative | 18 | 26 | 0.076 | 350 | 3 | 60 | Fair |
| Example 12 | | | | | | | |
| Comparative | 17 | 23 | 0.080 | 350 | 60 | 60 | Good |
| Example 13 | | | | | | | |
| Comparative | 9 | 12 | 0.090 | 350 | 2 | 60 | Fair |
| Example 14 | 7 | 10 | 0.090 | 350 | 2 | 60 | Fair |
| Comparative | 35 | 52 | 0.030 | 350 | 5 | 60 | Fair |
| Example 15 | | | | | | | |

The time before whitening of the polyamide-imide solution of each of Examples 1 to 17 was equal to or longer than 5 minutes, unlike that of the polyamide-imide solution or polyamide-amide acid solution of each of Comparative Examples 1 to 15. Further, the time before establishment of the tack-free state in the polyamide-imide solution of each of Examples 1 to 17 was equal to or longer than 45 minutes, unlike that of the polyamide-imide solution or polyamide-amide acid solution of each of Comparative Examples 1 to 15. This means that the polyamide-imide solution of each of Examples 1 to 17 was excellent in coating applicability. Further, the polyamide-imide film obtained had a very low thermal expansion coefficient. In addition, as compared to the polyamide-imide film obtained in Comparative Example 15, the polyamide-imide films obtained in Examples 1 to 17 each had a lower linear thermal expansion coefficient and a higher birefringence.

### INDUSTRIAL APPLICABILITY

The polyamide-imide solution of the present invention has a high dimensional stability and a high solubility in an organic solvent, in addition to characteristics, such as heat resistance, insulating property, and the like, that are inherent in polyamide-imide. Further, the polyamide-imide solution of the present invention is excellent in coating applicability. Therefore, the polyamide-imide solution of the present invention can be suitably employed in fields or products in which the above-described characteristics are effective. Examples of such fields or products are: optical materials such as a printed matter, a color filter, a flexible display substrate, a TFT substrate, an optical film, and the like; an image display device such as a liquid crystal display device, an organic EL, and the electronic paper; an electronic device material; and solar cells. Further, the polyamide-imide solution of the present invention can also be applied as a replacement material for a portion for which glass is currently used.

1. A polyamide-imide solution comprising:
an organic solvent; and
a polyamide-imide including a structure represented by the general formula (1): 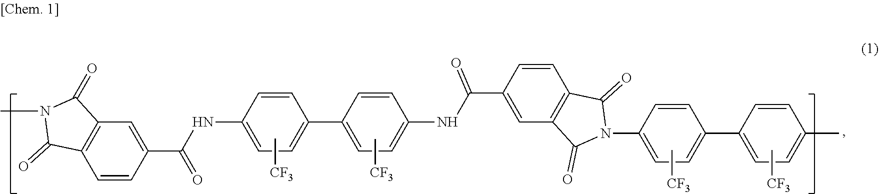
the organic solvent being a mixture solvent of an amide solvent and a non-amide solvent,
the non-amide solvent being at least one solvent selected from the group consisting of ether solvents, ketone solvents, ester solvents, glycol ether solvents, and glycol ester solvents.

2. The polyamide-imide solution as set forth in claim 1, wherein a weight ratio of the amide solvent and the non-amide solvent (amide solvent/non-amide solvent) is in a range of 80/20 to 5/95.

3. The polyamide-imide solution as set forth in claim 1, wherein:
the polyamide-imide including the structure represented by the general formula (1) is a polyamide-imide represented by the general formula (6):

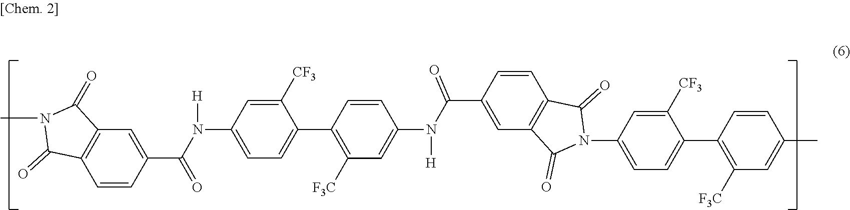

4. The polyamide-imide solution as set forth in claim 1, wherein:
the amide solvent is N,N-dimethylacetamide or N,N-dimethylformamide; and
the non-amide solvent is at least one solvent selected from the group consisting of methyl ethyl ketone, methyl isobutyl ketone, cyclohexanone, cyclopentanone, propyleneglycol monomethylether acetate, methyl triglyme, methyl tetraglyme, methyl monoglyme, methyl diglyme, ethyl monoglyme, ethyl diglyme, butyl diglyme, and γ-butyrolactone.

5. A polyamide-imide film comprising a polyamide-imide including a structure represented by the general formula (1): 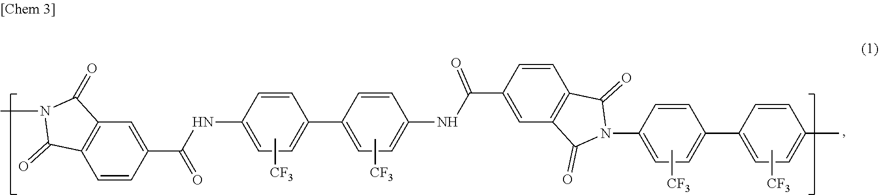
the polyamide-imide film having a birefringence ΔN of 0.040 or higher,
the birefringence being expressed by ΔN=Nxy−Nz, where Nxy is an in-plane refractive index and Nz is a refractive index in a thickness direction.

6. A polyamide-imide film obtained by forming a film from a polyamide-imide solution as set forth in claim 1.

7. The polyamide-imide film as set forth in claim 5, obtained by forming a film from a polyamide-imide solution,
the polyamide-imide solution including:
an organic solvent; and
a polyamide-imide including a structure represented by the general formula (1),
the organic solvent being a mixture solvent of an amide solvent and a non-amide solvent,
the non-amide solvent being at least one solvent selected from the group consisting of ether solvents, ketone solvents, ester solvents, glycol ether solvents, and glycol ester solvents.

8. The polyamide-imide film as set forth in claim 6, obtained by applying the polyamide-imide solution onto a support.

9. The polyamide-imide film as set forth in claim 5, having a linear thermal expansion coefficient of 22 ppm/K or less at a temperature in a range of 100° C. to 300° C.

10. The polyamide-imide film as set forth in claim 5, wherein:
the birefringence ΔN is 0.070 or more and 0.30 or less,
the birefringence ΔN being expressed by ΔN=Nxy−Nz, where Nxy is an in-plane refractive index and Nz is an refractive index.

11. A laminate comprising:
a polyamide-imide film as set forth in claim 5; and
a glass substrate.

12. A flexible display substrate comprising a polyamide-imide film as set forth in claim 5.

13. A TFT substrate comprising a polyamide-imide film as set forth in claim 5.

14. A color filter comprising a polyamide-imide film as set forth in claim 5.

15. An electronic paper comprising a polyamide-imide film as set forth in claim 5.

16. An organic EL display comprising a polyamide-imide film as set forth in claim 5.

17. The polyamide-imide film as set forth in claim 7, obtained by applying the polyamide-imide solution onto a support.

18. The polyamide-imide film as set forth in claim 6, having a linear thermal expansion coefficient of 22 ppm/K or less at a temperature in a range of 100° C. to 300° C.

19. The polyamide-imide film as set forth in claim 6 wherein:
the birefringence ΔN is 0.070 or more and 0.30 or less,
the birefringence ΔN being expressed by ΔN=Nxy−Nz, where Nxy is an in-plane refractive index and Nz is an refractive index.
